(19) United States
(12) Patent Application Publication
(10) Pub. No.: US 2004/0120504 A1
(43) Pub. Date: Jun. 24, 2004

(54) System for the automatic update of a subscriber's telephone number directory

(76) Inventor: William Jackson Bushnell, St. Charles, IL (US)

Correspondence Address: PATTON BOGGS, 1660 LINCOLN ST, SUITE 2050, DENVER, CO, 80264, US

(21) Appl. No.: 10/329,206

(22) Filed: Dec. 23, 2002

(51) Int. Cl. H04M 1/00; H04M 3/00

(52) U.S. Cl. 379/355.04; 379/355.09

(57) ABSTRACT

The Click to Dial Favorites system maintains a listing of only the subscriber's most frequently accessed telephone numbers to thereby parse the universe of all telephone numbers available to the Click to Dial feature down to a minimal set that are relevant to the subscriber. The Click to Dial Favorites system maintains a record of the incoming and outgoing calls for individual subscribers. On subsequent searches of large telephone directories, the results of the search are compared to the entries in the subscriber's Click to Dial Favorites Database. Entries in the search results that have been previously called by the subscriber or have called the subscriber are highlighted. Similarly, the results of the search can be filtered to only show the subscriber entries that have been previously called or have called the subscriber.

### Field of the Invention

This invention relates to telephone communication systems and, in particular, to a system for the automatic update of a subscriber's telephone number directory.

Problem

It is a problem in the field of telephone communication systems to locate the telephone number of a party (called party) whom the subscriber wishes to call. Locating the called party's telephone number can be problematic due to the multitude of locations that may have the required data.

For example, business customers place many outgoing telephone calls. To place a call, the subscriber must first determine the telephone number of the person or organization they want to call. To determine the called party's number, subscribers frequently refer to formal telephone listings, such as: organization charts, corporate telephone directories, public telephone directories, personal telephone directories, or informal telephone number listings, such as: notes in files, telephone message slips, note pads, e-mail messages, and the like. The formal telephone listings can either be stored on paper records, personal digital assistants (PDAs) or in an on-line web server, while the informal telephone number listings are typically stored on paper records, although they too can be stored on personal digital assistants (PDAs) or in an on-line web server. These diverse records are sometimes redundant, are typically incompatible and not cross-referenced or organized in any manner.

With the advent of Computer Telephony Integration (CTI) service, Personal Computers and telephone systems are interconnected. With the new Click to Dial service provided by the Computer Telephony Integration service, a subscriber can access a Telephone Directory Search Engine via their personal computer, enter a string of characters to specify the called party the subscriber wants to call and then “click” on the called party entry to initiate a telephone call. While this is more efficient than manually looking up the called number and entering the number via the telephone station set, there are several drawbacks. A large corporate directory may have tens of thousands of entries. Public directories may have millions of entries. To locate a called party in the directory, the subscriber must be able to spell the last name of the called party. If the called party has a common last name, the subscriber must also enter the first name and middle initial. Sometimes people user their middle name as their first name. This can lead to confusion in locating the correct entry. Sometimes, the directory may contain first names or nick names. As a result, “William” may be listed as “Bill”. “James” may be listed as “Jim” and “Robert” may be listed as “Bob”. The net effect is that the subscriber struggles to find the appropriate entry for the called party. To help eliminate these problems, modern Telephone Directory Search Engines allow subscribers to enter subsets of the total name or to request the directory to search for names that are similar to the name entered by the subscriber. The results can be that the Telephone Directory Search Engine returns dozens of entries that match the search criteria. This results in the subscriber having to scan the entries in an attempt to determine the desired listing for the called party.

Thus, while the Click to Dial feature of the Computer Telephony Integration service is an improvement over paper records, it has shortcomings that affect its effectiveness in quickly providing the subscriber with the telephone number of the called party.

Solution

The above-described problems are solved and a technical advance achieved by the present system for the automatic update of a subscriber's telephone number directory (termed “Click to Dial Favorites system” herein) which maintains a listing of only the subscriber's most frequently accessed telephone numbers to thereby parse the universe of all telephone numbers available to the Click to Dial feature down to a minimal set that are relevant to the subscriber.

To help subscribers more easily find entries and, in particular, entries that are repetitively accessed by the subscriber, the Click to Dial Favorites system provides several enhancements to the Telephone Directory Search process. The Click to Dial Favorites system maintains a record of the incoming and outgoing calls for individual subscribers. With this system, each time the subscriber searches a directory and clicks on an entry to dial a number, the number dialed is recorded in the subscriber's Click to Dial Favorites Database. Similarly, each time a subscriber receives a call, the telephone number of the calling party is recorded in the subscriber's Click to Dial Favorites Database. On subsequent searches of large telephone directories, the results of the search are compared to the entries in the subscriber's Click to Dial Favorites Database. Entries in the search results that have been previously called by the subscriber or have called the subscriber are highlighted. Similarly, the results of the search can be filtered to only show the subscriber entries that have been previously called or have called the subscriber.

In this manner, the effectiveness of the telephone number directory search process is improved and the subscriber is presented with a list of only the subscriber's most frequently accessed telephone numbers to thereby parse the universe of all telephone numbers available to the Click to Dial feature down to a minimal set that are relevant to the subscriber.

### BRIEF DESCRIPTION OF THE DRAWINGS

FIG. 1 illustrates, in block diagram form, the overall architecture of the Click to Dial Favorites system and a typical telephone communications system in which it is operational;

FIG. 2 illustrates, in flow diagram form, the operational steps taken by the Click to Dial Favorites system in generating a database of frequently called telephone numbers for the subscriber; and

FIG. 3 illustrates, in flow diagram form, the operational steps taken by the Click to Dial Favorites system in retrieving selected entries in response to the subscriber initiating an outgoing call using the telephone directory search process.

### DETAILED DESCRIPTION OF THE DRAWINGS

The present Click to Dial Favorites system, summarized above and defined by the enumerated claims, may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

### CLICK TO DIAL FAVORITES SYSTEM ARCHITECTURE AND APPLICATION ENVIRONMENT

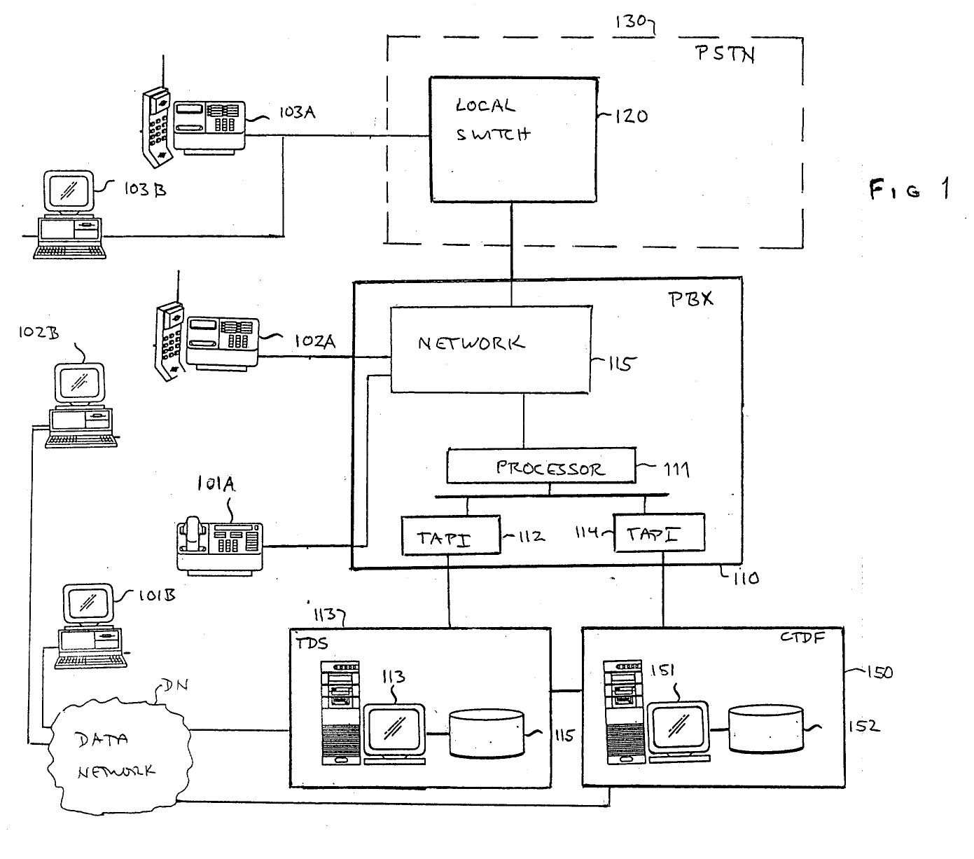

FIG. 1 illustrates, in block diagram form, the overall architecture of the Click to Dial Favorites system 150 and a typical telephone communications system in which it is operational. As shown in FIG. 1, a typical telephone communications network environment includes a customer premises switching system, such as Private Branch exchange (PBX) 110, which serves to interconnect a plurality of telephone station sets 101A, 102A and their associated data communications terminals 101B, 102B with the local central office switching system 120 of the Public Switched Telephone Network 130. In addition, the local central office switching system 120 can serve individual telephone station sets 103A and their associated data communications terminals 103B. The PBX (termed “telephone switching system” herein) 110 is typically equipped with various telecommunications features and apparatus, such as the Computer Telephony Integration system 140 and a telephone directory search system 113 which is connected via a Telephone Application Processor Interface (TAPI). These elements are well known in the art and are not described in additional detail herein for the sake of simplicity of description. The Click to Dial Favorites system 150 is connected via a standard Telephone Application Programming Interface (TAPI) 114 to telephone switching system 110 that serves the end subscribers′telephone station sets 101A, 102A and their associated data communications terminals 101B, 102B. Alternatively, the Click to Dial Favorites system 150 can be connected to the local central office switching system 120 of the Public Switched Telephone Network 130 to serve the subscribers connected to this system, but that alternative is not described herein. The operation of the Click to Dial Favorites system 150 in that application would be analogous to the operation described herein.

The Click to Dial Favorites system 150 has a Click to Dial Favorites server 151 and a database 152 which records the subscriber's called telephone numbers and the telephone numbers of incoming calls. The Click to Dial Favorites system 150 is also connected to a standard Telephone Directory Search Engine 113 with its associated Telephone Directory Database 115.

### Operation of the Click to Dail Favorites System to Create Database Entries

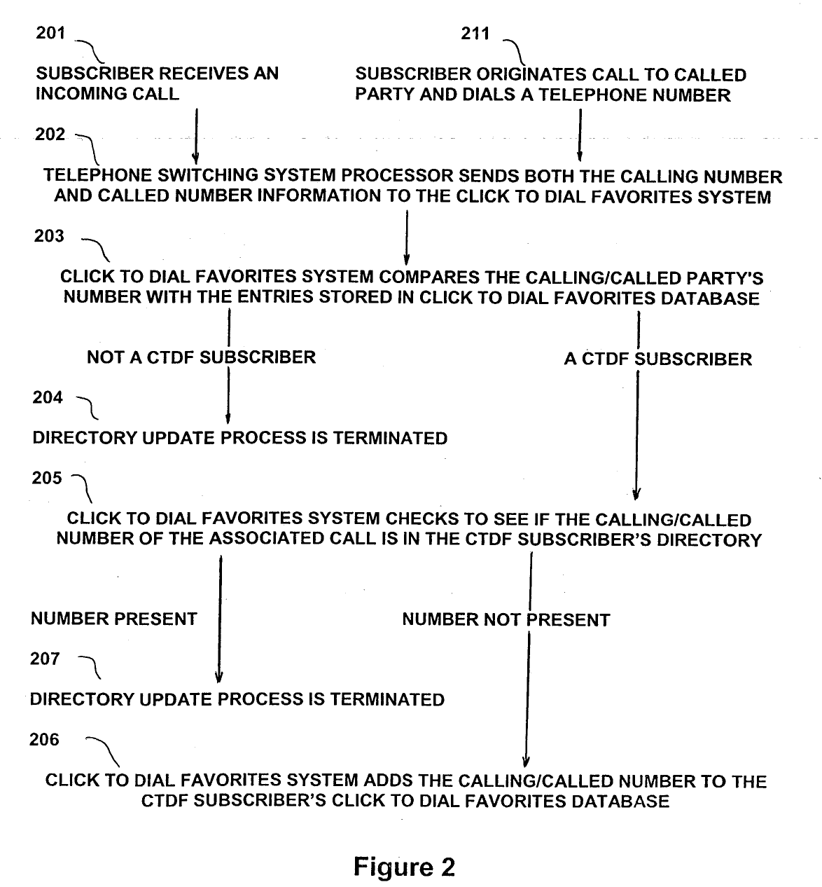

FIG. 2 illustrates, in flow diagram form, the operational steps taken by the Click to Dial Favorites system 150 in generating a database of frequently called telephone numbers for the subscriber. The Click to Dial Favorites system 150 collects information about the end subscriber's calling patterns or favorite numbers. The data is collected on both incoming calls and outgoing calls.

1) Incoming Calls—When the subscriber receives an incoming call at step 201, the processor 111 of the telephone switching system 110 at step 202 sends both the calling number and called number information to the Click to Dial Favorites system 150 via the Telephone Application Processor Interface 114 and the call is completed by the telephone switching system 110 in routine fashion. At step 203, the Click to Dial Favorites system 150 compares the subscriber's number (called number for an incoming call) with the entries stored in Click to Dial Favorites database 152 to determine whether a Click to Dial Favorites subscriber is assigned the called number. If the called number is not assigned to a subscriber to the Click to Dial Favorites service, the directory update process is terminated at step 204. If the called number is assigned to a subscriber, the Click to Dial Favorites system 150 at step 205 checks to see if the calling number of the associated incoming call is in the subscriber's directory of the Click to Dial Favorites database 152. If the calling number is not in the subscriber's database, the Click to Dial Favorites system 150 adds the calling number to the subscriber's Click to Dial Favorites database 152 at step 206. If the calling number is already in the subscriber's Click to Dial Favorites database 152, at step 207 the directory update process is terminated.

2) Outgoing Calls—When the subscriber originates a call to a called party and dials a telephone number at step 211, the processor 111 of the telephone switching system 110 sends both the calling number and the called number to the Click to Dial Favorites system 150 via the Telephone Application Processor Interface 114 at step 202 and the call is completed by the telephone switching system 110 in routine fashion. At step 203, the Click to Dial Favorites system 150 compares the subscriber's number (calling number for an outgoing call) with the entries stored in Click to Dial Favorites database 152 to determine whether the user subscribes to the a Click to Dial Favorites service. If the calling number is not assigned to a subscriber to the Click to Dial Favorites service, the directory update process is terminated at step 204. If the calling number is assigned to a subscriber, the Click to Dial Favorites system 150 at step 205 checks to see if the called number of the associated outgoing call is in the subscriber's directory of the Click to Dial Favorites database 152. If the called number is not in the subscriber's database, the Click to Dial Favorites system 150 adds the called number to the subscriber's Click to Dial Favorites database 152 at step 206. If the called number is already in the subscriber's Click to Dial Favorites database 152, at step 207 the directory update process is terminated. Note that subscriber may have initiated the call by entering the digits on the telephone station set 101A, or by use the Click to Dial service.

### Operation of the Click to Dial Favorites System for Searching Telephone Directories

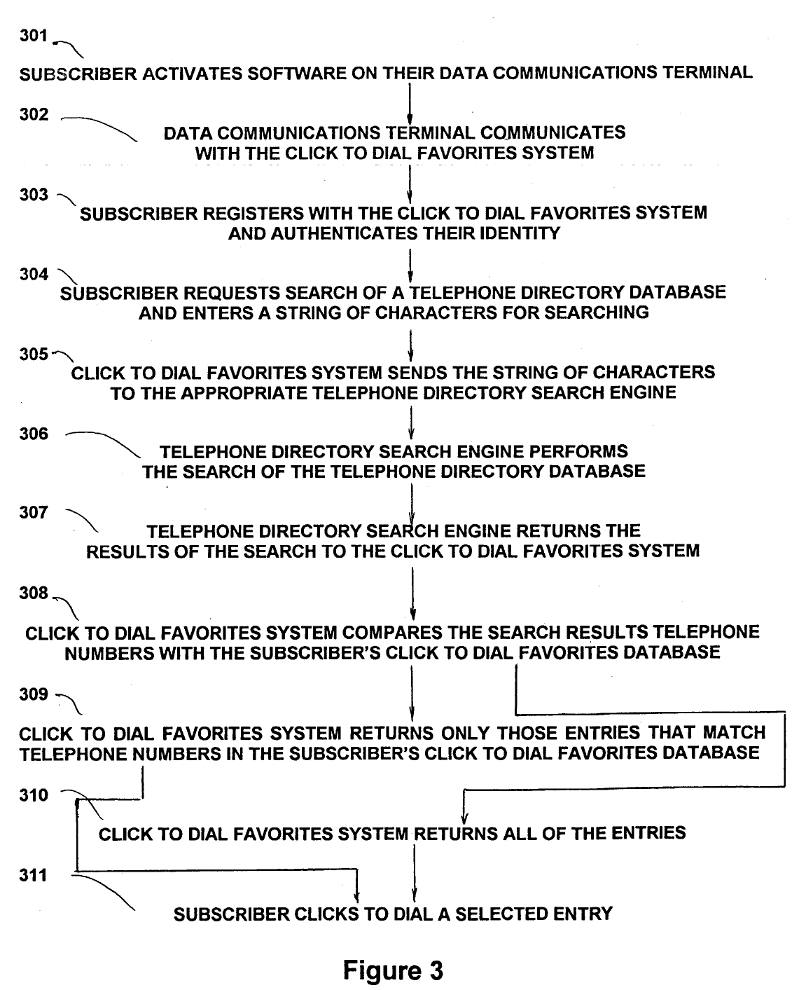

FIG. 3 illustrates, in flow diagram form, the operational steps taken by the Click to Dial Favorites system 150 in retrieving selected entries in response to the subscriber initiating an outgoing call using the telephone directory search process.

The Click to Dial Favorites system 150 assists the subscriber who is initiating an outgoing call in finding the desired called party telephone number entry in a long list of telephone number entries generated by the Telephone Directory Search Engine 113. When the subscriber wants to use a Telephony Directory Search Engine 113 and Click to Dial Favorites service, the subscriber activates software on their data communications terminal 101B at step 301 which causes the data communications terminal 101B to communicate with the Click to Dial Favorites system 150 over a data network associated with the telephone switching system 110 at step 302. The data network interconnects the data communications terminals, the Telephone Directory Search Engine, the Click to Dial Favorites system and the Telephone Application Processor Interface to the telephone switching system. Typically, this data network is implemented as a client/server arrangement using an IP data network. The subscriber registers with the processor 151 of the Click to Dial Favorites system 150 and authenticates their identity at step 303. The subscriber requests a search of a Telephone Directory Database 115 and enters a string of characters for searching the Telephone Directory Database 115 at step 304. This might include the last name, first name, location or any other information that might help narrow the search. The processor 151 of the Click to Dial Favorites system 150 at step 305 sends the string of characters to the appropriate Telephone Directory Search Engine 113. The Telephone Directory Search Engine 113 performs the search of the Telephone Directory Database 115 at step 306 and returns the results of the search to the Click to Dial Favorites system 150 at step 307. The results typically include many entries from the Telephone Directory Database 115 that matches the search parameters.

The processor 151 of the Click to Dial Favorites system 150 at step,308 compares the telephone numbers in the results of the search of the Telephone Directory Database 115 with the telephone numbers in the subscriber's Click to Dial Favorites Database 152. As requested by the subscriber, the Click to Dial Favorites system 150 can either filter the results of the search to excerpt only those entries that match telephone numbers in the subscriber's Click to Dial Favorites Database 152 from the results, which excerpted entries are then returned to the subscriber's data communications terminal 101B at step 309. Alternatively, the Click to Dial Favorites system 150 at step 310 can return all of the entries in the result of the search of Telephone Directory Database 115 to the subscriber's data communications terminal 101B but indicate which entries have telephone numbers that are also in the Click to Dial Favorites Database 152 for the subscriber. The indication of which entries are in the subscriber's Click to Dial Favorites Database 152 can be accomplished by coloring coding the entries or other similar graphical techniques. The subscriber can then select an entry for automated dialing via the Click to Dial feature at step 311, which feature can automatically be activated by the Click to Dial Favorites system 150 as part of the return of data to the subscriber's data communications terminal 101B.

### Alternative Embodiments

The above description of the Click to Dial Favorites system 150 is based on searching Telephone Directories. However, this same technique can be applied to other applications. For example, when subscribers want to send an email they often need to search an email directory to find the email address of the intended email recipient. A similar Click to Dial Favorites system 150 that monitors inbound and outbound email address and can be used to filter multiple entries in a search results file from an Email Directory Search Engine (not shown). In other applications, a subscriber may be searching an airline flight guide or a list of hotels in a particular city. The subscriber's past travel itineraries could be used to highlight flights or hotels previously used.

The Click to Dial Favorites system 150 can also be expanded to allow sharing of database information, where an end subscriber can access the Click to Dial Favorites Database 152 of a co-worker of a group of co-workers. This would be helpful in attempting to locate a telephone number of a client when the primary salesperson for that client is not available. The Click to Dial Favorites system 150 can also be expanded to support a cell phone. It can also be expanded to combine the subscriber's calling and called numbers from their cell phone and their office phone. Over time, the subscriber's Click to Dial Favorites Database 152 could have so many entries that it becomes useless in helping to filter the results of the Telephone Directory Search Engine. To keep the list manageable the Click to Dial Favorites system 150 could be expanded to allow the subscriber to edit their Click to Dial Favorites Database 152. Similarly, the Click to Dial Favorites system 150 could date each entry and delete entries after a fixed time.

### Summary

The Click to Dial Favorites system maintains a record of the incoming and outgoing calls for individual subscribers. On subsequent searches of large telephone directories, the results of the search are compared to the entries in the subscriber's Click to Dial Favorites Database. Entries in the search results that have been previously called by the subscriber or have called the subscriber are highlighted. Similarly, the results of the search can be filtered to only show the subscriber entries that have been previously called or have called the subscriber.

What is claimed:

1. A telephone number directory update system for automatically populating a database of telephone numbers for use by a subscriber in dialing outgoing calls, comprising:
subscriber identification means, responsive to initiation of a call connection in a telephone switching system, for determining whether the telephone number served by said telephone switching system represents the telephone number of a subscriber to said telephone number directory update system; and
directory update means, responsive to said subscriber identification means, for updating a telephone number directory of said subscriber.

2. The system for the automatic update of a subscriber's telephone number directory of claim 1, further comprising:
database means for storing in a memory a telephone number directory, comprising entries each of which contain a telephone number of a party with whom the subscriber communicates, for each of a plurality of subscribers.

3. The system for the automatic update of a subscriber's telephone number directory of claim 2, wherein said directory update means comprises:
database comparison means for comparing a telephone number received from said telephone switching system with entries stored in a directory in said database means for said subscriber; and
database entry means, responsive to said telephone number failing to match said entries stored in a directory in said database means for said subscriber, for storing said telephone number said directory in said database means for said subscriber.

4. The system for the automatic update of a subscriber's telephone number directory of claim 2, further comprising:
directory search means for activating a telephone directory search process in response to data, identifying a called party, received from said subscriber.

5. The system for the automatic update of a subscriber's telephone number directory of claim 4, further comprising:
telephone number filter means, responsive to receipt of telephone number data from said telephone directory search process, for identifying entries contained in said telephone number data received from said telephone directory search process that correspond to said entries in said telephone number directory of said subscriber.

6. The system for the automatic update of a subscriber's telephone number directory of claim 5, further comprising:
outgoing call completion means, responsive to said subscriber selecting a one of said identified entries, for initiating an outgoing call to a telephone number identified in said selected one of said identified entries.

7. The system for the automatic update of a subscriber's telephone number directory of claim 5, wherein said telephone number filter means comprises:
highlighting means for returning data to said subscriber that includes highlighting of all of said identified entries contained in said telephone number data received from said telephone directory search process that correspond to said entries in said telephone number directory of said subscriber.

8. The system for the automatic update of a subscriber's telephone number directory of claim 5, wherein said telephone number filter means comprises:
excerpting means for returning to said subscriber only ones of said identified entries contained in said telephone number data received from said telephone directory search process that correspond to said entries in said telephone number directory of said subscriber.

9. A method of automatically populating a database of telephone numbers for use by a subscriber in dialing outgoing calls, comprising:
determining, in response to initiation of a call connection in a telephone switching system, whether the telephone number served by said telephone switching system represents the telephone number of a subscriber to said telephone number directory update system; and
updating, in response to said step of determining, a telephone number directory of said subscriber.

10. The method of automatically populating a database of telephone numbers for use by a subscriber in dialing outgoing calls of claim 9, further comprising:
storing in a memory a telephone number directory, comprising entries each of which contain a telephone number of a party with whom the subscriber communicates, for each of a plurality of subscribers.

11. The method of automatically populating a database of telephone numbers for use by a subscriber in dialing outgoing calls of claim 10, wherein said step of updating comprises:
comparing a telephone number received from said telephone switching system with entries stored in a directory in said memory for said subscriber; and
storing, in response to said telephone number failing to match said entries stored in a directory in said memory for said subscriber, said telephone number said directory in said memory for said subscriber.

12. The method of automatically populating a database of telephone numbers for use by a subscriber in dialing outgoing calls of claim 10, further comprising:
activating a telephone directory search process in response to data, identifying a called party, received from said subscriber.

13. The method of automatically populating a database of telephone numbers for use by a subscriber in dialing outgoing calls of claim 12, further comprising:
identifying, in response to receipt of telephone number data from said telephone directory search process, entries contained in said telephone number data received from said telephone directory search process that correspond to said entries in said telephone number directory of said subscriber.

14. The method of automatically populating a database of telephone numbers for use by a subscriber in dialing outgoing calls of claim 12, further comprising:
initiating, in response to said subscriber selecting a one of said identified entries, an outgoing call to a telephone number identified in said selected one of said identified entries.

15. The method of automatically populating a database of telephone numbers for use by a subscriber in dialing outgoing calls of claim 13, wherein said step of identifying comprises:
returning data to said subscriber that includes highlighting of all of said identified entries contained in said telephone number data received from said telephone directory search process that correspond to said entries in said telephone number directory of said subscriber.

16. The method of automatically populating a database of telephone numbers for use by a subscriber in dialing outgoing calls of claim 13, wherein said step of identifying comprises:
returning to said subscriber only ones of said identified entries contained in said telephone number data received from said telephone directory search process that correspond to said entries in said telephone number directory of said subscriber.
